(19) United States
(12) Patent Application Publication
(10) Pub. No.: US 2020/0328452 A1
(43) Pub. Date: Oct. 15, 2020

(54) SOLID ELECTROLYTE SHEET, ALL-SOLID-STATE BATTERY, SEPARATOR, AND LITHIUM ION BATTERY

(71) Applicant: HONDA MOTOR CO., LTD., Tokyo (JP)

(72) Inventors: Wataru Shimizu, Wako-shi (JP); Masahiro Ohta, Wako-shi (JP)

(21) Appl. No.: 16/835,359

(22) Filed: Mar. 31, 2020

(30) Foreign Application Priority Data
Apr. 10, 2019 (JP) 2019-074859

(51) Int. Cl. H01M 10/0562; H01M 10/0525; H01M 4/134; H01M 4/66; H01M 2/16

(52) U.S. Cl. CPC H01M 10/0562; H01M 10/0525; H01M 4/134; H01M 2004/028; H01M 4/668; H01M 2/1673; H01M 4/664

(57) ABSTRACT

A solid electrolyte layer 40 is formed of a solid electrolyte sheet which has a central part 41 including a solid electrolyte, and an outer circumferential part 42 positioned on an outer circumference of the central part 41 and containing a non-ion conductive insulating material.

### CROSS-REFERENCE TO RELATED APPLICATION

Priority is claimed on Japanese Patent Application No. 2019-074859, filed Apr. 10, 2019, the content of which is incorporated herein by reference.

### BACKGROUND OF THE INVENTION

### Field of the Invention

The present disclosure relates to a solid electrolyte sheet, an all-solid-state battery, a separator, and a lithium ion battery.

### Description of Related Art

In order to secure and maintain a performance at the time of design, an all-solid-state battery, in a state in which a laminate is formed by laminating a positive electrode, a solid electrolyte layer, and a negative electrode, needs to be press-formed at a high surface pressure to have a high bonding force and maintain the bonding state thereafter. As such a manufacturing method, for example, a manufacturing method in which a sheet with a solid electrolyte disposed on an upper surface of a sheet of an electrode mixture in which the electrode mixture is applied on both surfaces of a current collector foil is cut into an arbitrary shape, and a positive electrode and a negative electrode are alternately laminated and then press-formed has been proposed (Patent Document 1).

On the other hand, as can be seen in conventional lithium ion batteries (aqueous LIBs) or the like, when a battery having a laminated structure in which punched electrodes are laminated is formed, in order to avoid a risk of electrolytic deposition of lithium which may occur due to a positional deviation of electrodes, generally, electrodes are laminated such that an area of a negative electrode is larger than an area of a positive electrode (Patent Document 2).

### PATENT DOCUMENTS

[Patent Document 1] Japanese Unexamined Patent Application, First Publication No. 2015-118870

[Patent Document 2] Japanese Patent Publication No. 5354646

### SUMMARY OF THE INVENTION

However, in the manufacturing method in which a positive electrode and a negative electrode are alternately laminated and press-formed as an assembly package of an all-solid-state battery as in Patent Document 1, when the positive electrode and the negative electrode are different in size as in Patent Document 2 described above, it is difficult to align the positive electrodes and the negative electrodes alternately laminated with a solid electrolyte layer interposed therebetween, and a relative positional deviation between the positive electrode, the solid electrolyte layer, and the negative electrode is likely to occur. Also, at the time of press forming of the all-solid-state battery, a pressed portion to which pressure is applied via the positive electrode and an unpressed portion to which pressure is not applied occur in the solid electrolyte layer, cracks or defects may occur near these boundary portions, particularly at end portions of the solid electrolyte layer, and there is a problem in that a yield is reduced. On the other hand, when the pressure at the time of press forming is reduced to reduce the risk of cracks, defects, or the like that may occur in the solid electrolyte layer, an initial performance, deterioration characteristics, and furthermore, an energy density of the all-solid-state battery may worsen.

An objective of the present disclosure is to provide a solid electrolyte sheet, an all-solid-state battery, a separator, and a lithium-ion battery capable of improving a yield of a battery and achieving improvement in initial performance, deterioration characteristics, and furthermore, an energy density.

In order to achieve the above-described objective, the present disclosure provides the following methods.

[1] A solid electrolyte sheet including a central part including a solid electrolyte, and an outer circumferential part positioned on an outer circumference of the central part and containing a material having electrical insulating properties and non-ionic conductivity.

[2] The solid electrolyte sheet according to the above-described [1], in which the material having electrical insulating properties and non-ionic conductivity is formed of one of a non-ion conductive insulating ceramic material and a non-ion conductive insulating resin material or formed of a composite material thereof.

[3] The solid electrolyte sheet according to the above-described [2], in which the non-ion conductive insulating ceramic material is formed of one or both of an oxide ceramic and a nitride ceramic.

[4] The solid electrolyte sheet according to the above-described [3], in which the oxide ceramic is one or more materials selected from the group consisting of Al₂O₃, Y₂O₃, MgO, CaO, SiO₂, ZrO₂, and TiO₂, and the nitride ceramic is one or more materials selected from the group consisting of MN and Si₃N₄.

[5] The solid electrolyte sheet according to the above-described [2], in which the non-ion conductive insulating resin material is formed of one or both of a thermoplastic resin and a thermosetting resin.

[6] The solid electrolyte sheet according to the above-described [5], in which the thermoplastic resin is one or more materials selected from the group consisting of polyethylene, polypropylene, polystyrene, polycarbonate, a methacrylate resin, and an ABS resin, and the thermosetting resin is one or more materials selected from the group consisting of a phenol resin, an epoxy resin, polyurethane, a silicone resin, and an alkyd resin.

[7] The solid electrolyte sheet according to the above-described [1], in which the outer circumferential part is formed over an entire circumference of the central part.

[8] The solid electrolyte sheet according to the above-described [1], in which the outer circumferential part is formed throughout the solid electrolyte sheet in a thickness direction thereof.

[9] The solid electrolyte sheet according to the above-described [1], in which the outer circumferential part is an impregnated part provided integrally with the solid electrolyte sheet and impregnated with the material having electrical insulating properties and non-ionic conductivity.

[10] The solid electrolyte sheet according to the above-described [1], in which the outer circumferential part is a lamina-shaped part formed on a main surface of the solid electrolyte sheet.

[11] An all-solid-state battery including a positive electrode layer, a negative electrode layer, and a solid electrolyte layer disposed between the positive electrode layer and the negative electrode layer and including a solid electrolyte, in which areas of the positive electrode layer, the solid electrolyte layer, and the negative electrode layer are substantially the same as each other on a plane of projection when they are projected in a lamination direction, and the solid electrolyte layer is formed of a solid electrolyte sheet having a central part including the solid electrolyte, and an outer circumferential part positioned on an outer circumference of the central part and containing a material having electrical insulating properties and non-ionic conductivity.

[12] The all-solid-state battery according to the above-described [11], in which the material having electrical insulating properties and non-ionic conductivity is formed of one of a non-ion conductive insulating ceramic material and a non-ion conductive insulating resin material or formed of a composite material thereof.

[13] The all-solid-state battery according to the above-described [12], in which the non-ion conductive insulating ceramic material is formed of one or both of an oxide ceramic and a nitride ceramic.

[14] The all-solid-state battery according to the above-described [13], in which the oxide ceramic is one or more materials selected from the group consisting of Al₂O₃, Y₂O₃, MgO, CaO, SiO₂, ZrO₂, and TiO₂, and the nitride ceramic is one or more materials selected from the group consisting of MN and Si₃N₄.

[15] The all-solid-state battery according to the above-described [12], in which the non-ion conductive insulating resin material is formed of one or both of a thermoplastic resin and a thermosetting resin.

[16] The all-solid-state battery according to the above-described [15], in which the thermoplastic resin is one or more materials selected from the group consisting of polyethylene, polypropylene, polystyrene, polycarbonate, a methacrylate resin, and an ABS resin, and the thermosetting resin is one or more materials selected from the group consisting of a phenol resin, an epoxy resin, polyurethane, a silicone resin, and an alkyd resin.

[17] The all-solid-state battery according to the above-described [11], in which the outer circumferential part is formed over an entire circumference of the central part.

[18] The all-solid-state battery according to the above-described [11], in which the outer circumferential part is formed throughout the solid electrolyte sheet in a thickness direction thereof.

[19] The all-solid-state battery according to the above-described [11], in which the outer circumferential part is an impregnated part provided integrally with the solid electrolyte sheet and impregnated with the material having electrical insulating properties and non-ionic conductivity.

[20] The all-solid-state battery according to the above-described [11], in which the outer circumferential part is a lamina-shaped part formed on a main surface on the positive electrode layer side of the solid electrolyte sheet.

[21] A separator including a central part including a separator substrate, and an outer circumferential part positioned on an outer circumference of the central part and containing a material having electrical insulating properties and non-ionic conductivity.

[22] A lithium-ion battery including a positive electrode layer, a negative electrode layer, and a separator disposed between the positive electrode layer and the negative electrode layer, in which areas of the positive electrode layer, the separator, and the negative electrode layer are substantially the same as each other on a plane of projection when they are projected in a lamination direction, and the separator has a central part including a separator substrate, and an outer circumferential part positioned on an outer circumference of the central part and containing a material having electrical insulating properties and non-ionic conductivity.

According to the present disclosure, a yield of a battery can be improved, and improvement in initial performance, deterioration characteristics, and furthermore, an energy density can be achieved.

### BRIEF DESCRIPTION OF THE DRAWINGS

FIG. 1 is an exploded perspective view showing an example of a configuration of a laminate unit having a solid electrolyte sheet according to a first embodiment of the present disclosure.

FIG. 2(a) is a cross-sectional view of a positive electrode layer, a solid electrolyte layer, and a negative electrode layer constituting the laminate unit of FIG. 1, and FIG. 2(b) is a cross-sectional view of a state in which the positive electrode layer, the solid electrolyte layer, and the negative electrode layer of FIG. 2(a) are laminated.

FIG. 3 is a perspective view showing an example of a configuration of a lamination-type all-solid-state battery including the solid electrolyte layer of FIG. 1.

FIG. 4 is a partial cross-sectional view taken along line I-I of a laminate constituting the all-solid-state battery of FIG. 3.

FIG. 5(a) is a perspective view showing a modified example of the solid electrolyte sheet of FIG. 1, and FIG. 5(b) is a cross-sectional view of the solid electrolyte sheet taken along line II-II of FIG. 5(a).

FIG. 6 is a perspective view showing an example of a configuration of a solid electrolyte sheet according to a second embodiment of the present disclosure.

FIG. 7 is a perspective view for explaining an example of a method of manufacturing a wound type all-solid-state battery formed by winding the solid electrolyte sheet of FIG. 6.

### DETAILED DESCRIPTION OF THE INVENTION

Hereinafter, embodiments of the present disclosure will be described in detail with reference to the drawings.

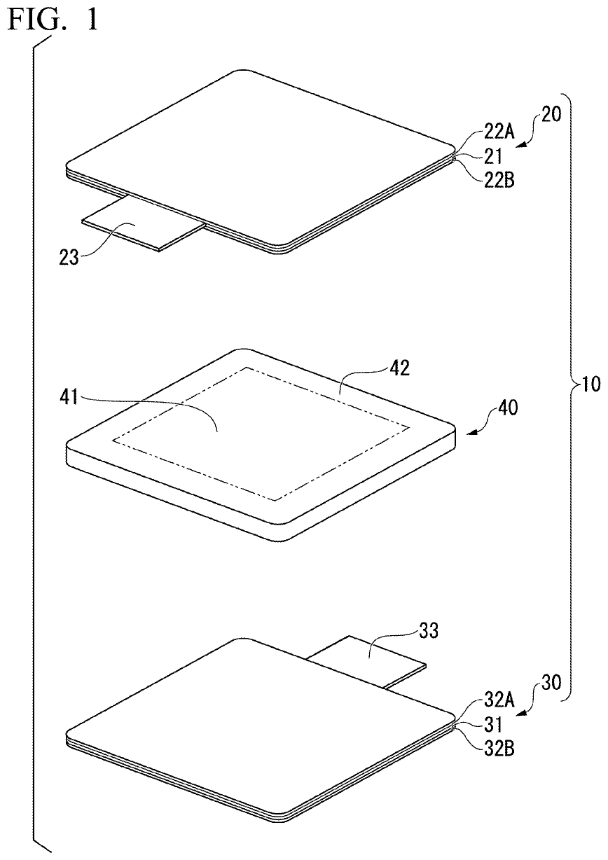

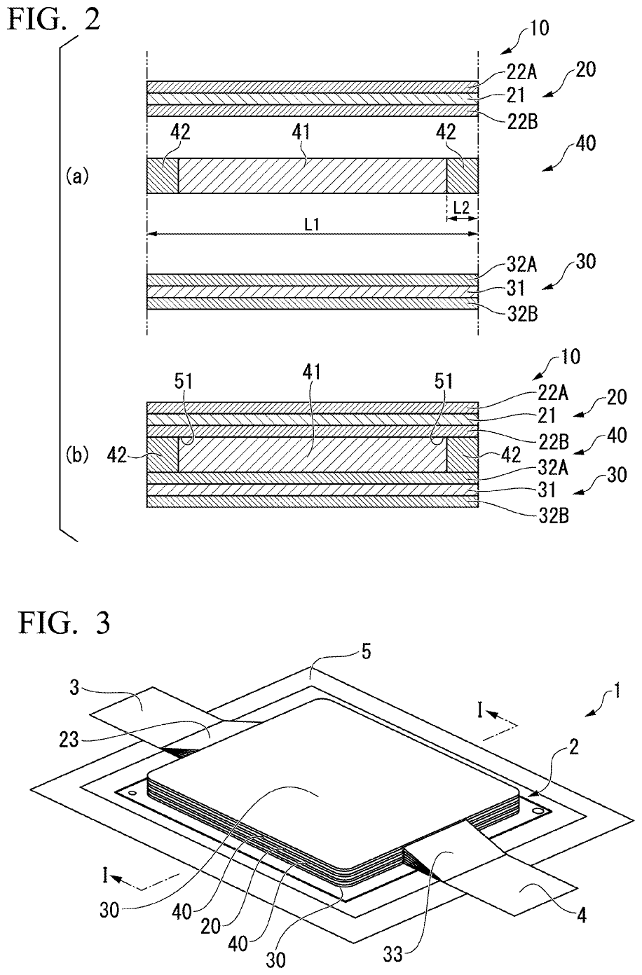

FIG. 1 is an exploded perspective view showing an example of a configuration of a laminate unit having a solid electrolyte sheet according to a first embodiment of the present disclosure, FIG. 2(a) is a cross-sectional view of a positive electrode layer, a solid electrolyte layer, and a negative electrode layer constituting the laminate unit of FIG. 1, and FIG. 2(b) is a cross-sectional view of a state in which the positive electrode layer, the solid electrolyte layer, and the negative electrode layer of FIG. 2(a) are laminated. In the drawings used in the following description, there are cases in which characteristic portions are enlarged for convenience of illustration so that characteristics thereof can be easily understood, and dimensional proportions or the like of respective constituent elements are not limited to those shown.

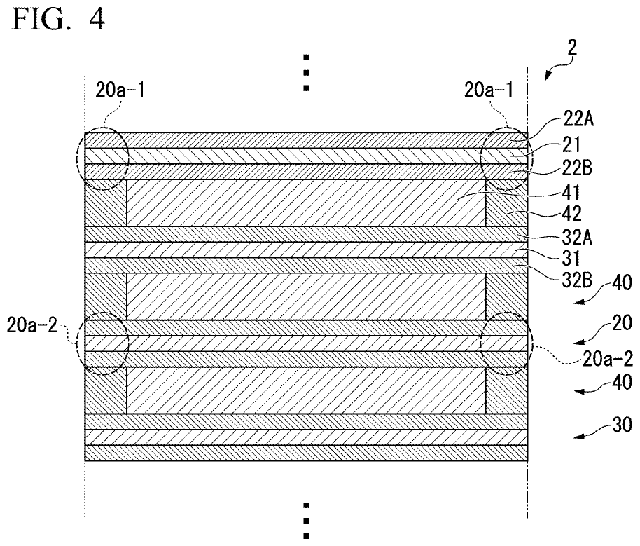

The laminate unit 10 includes a positive electrode layer 20, a negative electrode layer 30, and a solid electrolyte layer 40 (solid electrolyte sheet) disposed between the positive electrode layer 20 and the negative electrode layer 30 and containing a solid electrolyte. In a laminate to be described below, the positive electrode layer 20 and the negative electrode layer 30 are alternately laminated with the solid electrolyte layer 40 interposed therebetween (see FIG. 4). When lithium ions transfer between the positive electrode layer 20 and the negative electrode layer 30 via the solid electrolyte layer 40, charging and discharging of an all-solid-state battery is performed.

The positive electrode layer 20 includes a positive electrode current collector 21 and positive electrode active material layers 22A and 22B formed on both main surfaces of the positive electrode current collector 21 and containing a positive electrode active material.

The positive electrode current collector 21 is preferably formed of at least one material having high conductivity. As a material having high conductivity, a metal or alloy containing at least one metal element of, for example, silver (Ag), palladium (Pd), gold (Au), platinum (Pt), aluminum (Al), copper (Cu), chromium (Cr), and nickel (Ni), or a non-metal such as carbon (C) is exemplary examples. When manufacturing costs are considered in addition to the high conductivity, aluminum, nickel, or stainless steel is preferable. Further, aluminum does not easily react with a positive electrode active material, a negative electrode active material, and a solid electrolyte. Therefore, when aluminum is used for the positive electrode current collector 21, an internal resistance of the all-solid-state battery can be reduced.

As a form of the positive electrode current collector 21, a foil form, a plate form, a mesh form, a nonwoven fabric form, a foam form, and the like are exemplary examples. Also, in order to enhance adhesion to the positive electrode active material layers, carbon or the like may be disposed on surfaces of the current collector, or the surfaces may be roughened.

The positive electrode active material layers 22A and 22B contain a positive electrode active material that allows transfer of lithium ions and electrons thereto and therefrom. The positive electrode active material is not particularly limited as long as the material can release and occlude lithium ions reversibly and can transport electrons, and a known positive electrode active material applicable to a positive electrode layer of an all-solid-state lithium ion battery can be used. Complex oxides such as lithium cobalt oxide (LiCoO₂), lithium nickel oxide (LiNiO₂), lithium manganese oxide (LiMn₂O₄), solid solution oxide (Li₂MnO₃—LiMO₂ (M=Co, Ni, or the like)), lithium-manganese-nickel-cobalt oxide (LiNi_{1/3}Mn_{1/3}Co_{1/3}O₂), and olivine-type lithium phosphate (LiFePO₄); conductive polymers such as polyaniline and polypyrrole; sulfides such as Li₂S, CuS, Li—Cu—S compounds, TiS₂, FeS, MoS₂, and Li—Mo—S compounds; a mixture of sulfur and carbon; and the like are exemplary examples. The positive electrode active material may be formed of one of the above-described materials alone or may be formed of two or more thereof.

The positive electrode active material layers 22A and 22B include a solid electrolyte that allows lithium ions to be transferred to and from the positive electrode active material. The solid electrolyte is not particularly limited as long as it has lithium ion conductivity, and a material generally used for all-solid-state lithium ion batteries can be used. Iinorganic solid electrolytes such as a sulfide solid electrolyte material, an oxide solid electrolyte material, or a lithium-containing salt, polymer-based solid electrolytes such as polyethylene oxide, gel-based solid electrolytes containing a lithium-containing salt or ionic liquids having lithium ion conductivity, and the like are exemplary examples. The solid electrolyte may be formed of one of the above-described materials alone or may be formed of two or more thereof.

The solid electrolyte included in the positive electrode active material layers 22A and 22B may be the same as or different from a solid electrolyte included in negative electrode active material layers 32A and 32B or in the solid electrolyte layer 40.

The positive electrode active material layers 22A and 22B may contain a conductive auxiliary agent from a viewpoint of improving conductivity of the positive electrode layer 20. As the conductive auxiliary agent, a conductive auxiliary agent that can generally be used for all-solid-state lithium ion batteries can be used. Carbon black such as acetylene black or Ketjen black; carbon fibers; vapor-grown carbon fibers; graphite powder; and carbon materials such as carbon nanotubes are exemplary examples. The conductive auxiliary agent may be formed of one of the above-described materials alone or may be formed of two or more thereof.

Also, the positive electrode active material layers 22A and 22B may contain a binder having a role of binding the positive electrode active materials to each other and binding the positive electrode active material and the current collector.

In the present embodiment, the positive electrode active material layers 22A and 22B are formed on both main surfaces of the positive electrode current collector 21, but the present disclosure is not limited thereto, and one of the positive electrode active material layers 22A and 22B may be formed on one main surface of the positive electrode current collector 21. When the positive electrode layer 20 is a single-sided coated electrode, a laminated positive electrode that is laminated such that positive electrode current collector surfaces of two sheets of positive electrodes are combined may be used as a double-sided coated electrode. When the positive electrode current collector 21 has a three-dimensional porous structure such as a mesh form, a nonwoven fabric form, or a foam form, the positive electrode current collector 21 can be provided integrally with the positive electrode active material layers 22A and 22B.

The negative electrode layer 30 includes a negative electrode current collector 31 and the negative electrode active material layers 32A and 32B formed on both main surfaces of the negative electrode current collector 31 and containing a negative electrode active material.

Similarly to the positive electrode current collector 21, the negative electrode current collector 31 is preferably formed of at least one material having high conductivity. As a material having high conductivity, a metal or alloy containing at least one metal element of, for example, silver (Ag), palladium (Pd), gold (Au), platinum (Pt), aluminum (Al), copper (Cu), chromium (Cr), and nickel (Ni), or a non-metal such as carbon (C) is exemplary examples. When manufacturing costs are considered in addition to the high conductivity, copper, nickel, or stainless steel is preferable. Further, stainless steel does not easily react with a positive electrode active material, a negative electrode active material, and a solid electrolyte. Therefore, when stainless steel is used for the negative electrode current collector 31, an internal resistance of the all-solid-state battery can be reduced.

As a form of the negative electrode current collector 31, a foil form, a plate form, a mesh form, a nonwoven fabric form, a foam form, and the like are exemplary examples. Also, in order to enhance adhesion to the negative electrode active material layers, carbon or the like may be disposed on surfaces of the current collector, or the surfaces may be roughened.

The negative electrode active material layers 32A and 32B contain a negative electrode active material that allows transfer of lithium ions and electrons thereto and therefrom. The negative electrode active material is not particularly limited as long as the material can release and occlude lithium ions reversibly and can transport electrons, and a known negative electrode active material applicable to a negative electrode layer of an all-solid-state lithium ion battery can be used. Carbonaceous materials such as natural graphite, artificial graphite, resinous coal, carbon fibers, activated carbon, hard carbon, and soft carbon; alloy-based materials mainly formed of tin, tin alloy, silicon, silicon alloy, gallium, gallium alloy, indium, indium alloy, aluminum, aluminum alloy, and the like; conductive polymers such as polyacene, polyacetylene, and polypyrrole; metallic lithium; lithium-titanium complex oxides (for example, Li₄Ti₅O₁₂), and the like are exemplary examples. These negative electrode active materials may be formed of one of the above-described materials alone or may be formed of two or more thereof.

The negative electrode active material layers 32A and 32B include a solid electrolyte that allow lithium ions to be transferred to and from the negative electrode active material. The solid electrolyte is not particularly limited as long as it has lithium ion conductivity, and materials generally used for all-solid-state lithium ion batteries can be used. Inorganic solid electrolytes such as a sulfide solid electrolyte material, an oxide solid electrolyte material, and a lithium-containing salt, polymer-based solid electrolytes such as polyethylene oxide, gel-based solid electrolytes containing a lithium-containing salt or ionic liquids having lithium ion conductivity, and the like are exemplary examples. The solid electrolyte may be formed of one of the above-described materials alone or may be formed of two or more thereof.

The solid electrolyte included in the negative electrode active material layers 32A and 32B may be the same as or different from the solid electrolyte included in the positive electrode active material layers 22A and 22B or in the solid electrolyte layer 40.

The negative electrode active material layers 32A and 32B may contain a conductive auxiliary agent, a binder, or the like. Although there is no particular limitation on these materials, for example, the same materials as those used for the positive electrode active material layers 22A and 22B described above can be used.

In the present embodiment, the negative electrode active material layers 32A and 32B are formed on both main surfaces of the negative electrode current collector 31, but the present disclosure is not limited thereto, and one of the negative electrode active material layers 32A and 32B may be formed on one main surface of the negative electrode current collector 31. For example, when the negative electrode layer 30 is formed in a lowermost layer in a lamination direction of a laminate to be described below, there is no positive electrode layer 20 to face below the negative electrode layer 30 positioned on the lowermost layer. Therefore, in the negative electrode layer 30 positioned at the lowermost layer, the negative electrode active material layer 32A may be formed only on one surface on an upper side in the lamination direction. When the negative electrode current collector 31 has a three-dimensional porous structure such as a mesh form, a nonwoven fabric form, or a foam form, the negative electrode current collector 31 can be provided integrally with the negative electrode active material layers 32A and 32B.

The solid electrolyte layer 40 is formed of a solid electrolyte sheet which includes a central part 41 including the solid electrolyte and an outer circumferential part 42 positioned on an outer circumference of the central part 41 and containing a material having electrical insulating properties and non-ionic conductivity.

The solid electrolyte sheet of the present embodiment has a porous substrate and a solid electrolyte held by the porous substrate. Although there is no particular limitation on a form of the porous substrate, a woven fabric, a nonwoven fabric, a mesh cloth, a porous membrane, an expanding sheet, a punching sheet, and the like are exemplary examples. Among these forms, a nonwoven fabric is preferable from a viewpoint of a holding force of the solid electrolyte and handleability.

The porous substrate is preferably formed of an insulating material. Thereby, insulating properties of the solid electrolyte sheet can be improved. As the insulating material, a resin material such as nylon, polyester, polyethylene, polypropylene, polytetrafluoroethylene, ethylene-tetrafluoroethylene copolymer, polyvinylidene fluoride, polyvinylidene chloride, polyvinyl chloride, polyurethane, vinylon, polybenzimidazole, polyimide, polyphenylene sulfite, polyetheretherketone, cellulose, or acrylic resin; natural fibers such as hemp, wood pulp, or cotton linters; glass, and the like are exemplary examples.

The above-described solid electrolyte is not particularly limited as long as it has lithium ion conductivity and insulating properties, and materials generally used for all-solid-state lithium ion batteries can be used. Inorganic solid electrolytes such as a sulfide solid electrolyte material, an oxide solid electrolyte material, and a lithium-containing salt, polymer-based solid electrolytes such as polyethylene oxide, gel-based solid electrolytes containing a lithium-containing salt or ionic liquids having lithium ion conductivity, and the like are exemplary examples. Although there is no particular limitation on a form of the solid electrolyte material, for example, a particulate form is an exemplary example.

The solid electrolyte layer 40 may contain a pressure-sensitive adhesive for imparting a mechanical strength and flexibility.

The central part 41 includes a porous substrate and a solid electrolyte held by the porous substrate. That is, the central part 41 constitutes a part of a solid electrolyte layer substrate to be described below.

The outer circumferential part 42 may be, for example, an impregnated part provided integrally with the solid electrolyte sheet and impregnated with a material having electrical insulating properties and non-ionic conductivity. The impregnated part includes a porous substrate and a material having the electrical insulating properties and non-ionic conductivity described above. The impregnated part can be formed by attaching the material having electrical insulating properties and non-ionic conductivity to the porous substrate using, for example, a dipping method. The outer circumferential part 42 may include a solid electrolyte in addition to the porous substrate and the material having electrical insulating properties and non-ionic conductivity or may not include a solid electrolyte while including only the porous substrate and the material having electrical insulating properties and non-ionic conductivity.

The above-described material having non-ionic conductivity means a material having no or low ionic conductivity. Also, it is preferable that the material having non-ionic conductivity be a material having no lithium ion conductivity or low lithium ion conductivity.

The above-described material having electrical insulating properties and non-ionic conductivity may be, for example, formed of one of a non-ion conductive insulating ceramic material and a non-ion conductive insulating resin material or formed of a composite material thereof.

The non-ion conductive insulating ceramic material can be formed of one or both of an oxide ceramic and a nitride ceramic. The oxide ceramic may be, for example, one or more materials selected from the group consisting of Al₂O₃, Y₂O₃, MgO, CaO, SiO₂, ZrO₂, and TiO₂. The nitride ceramic may be, for example, one or more materials selected from the group consisting of AlN and Si₃N₄.

The non-ion conductive insulating resin material can be formed of one or both of a thermoplastic resin and a thermosetting resin. The thermoplastic resin may be, for example, one or more materials selected from the group consisting of polyethylene, polypropylene, polystyrene, polycarbonate, a methacrylate resin, and an ABS resin. The thermosetting resin may be, for example, one or more materials selected from the group consisting of a phenol resin, an epoxy resin, polyurethane, a silicone resin, and an alkyd resin.

In the present embodiment, the outer circumferential part 42 is formed over an entire circumference of the central part 41 (FIG. 1). Thereby, electrolytic deposition of lithium can be suppressed over an entire outer circumference of the laminate unit 10 (FIG. 2(b)). Also, the outer circumferential part 42 is preferably formed continuously over the entire circumference of the central part 41, but the present disclosure is not limited thereto, and the outer circumferential part 42 may be formed intermittently over the entire circumference of the central part 41.

Also, the outer circumferential part 42 is preferably formed throughout the solid electrolyte layer 40 in a thickness direction thereof, that is, throughout a thickness direction of the solid electrolyte sheet. Thereby, the electrolytic deposition of lithium can be further suppressed. However, the outer circumferential part 42 may be formed on a part in the thickness direction of the solid electrolyte sheet. In that case, the outer circumferential part 42 is formed on the positive electrode layer 20 side in the thickness direction of the solid electrolyte sheet.

Although the solid electrolyte sheet of the present embodiment has a porous substrate, the present disclosure is not limited thereto, and a solid electrolyte having electrical insulating properties and lithium ion conductivity may be disposed in the central part 41, and a material having electrical insulating properties and non-ionic conductivity may be disposed in the outer circumferential part 42 without the porous substrate provided in the solid electrolyte sheet. For example, a solid electrolyte sheet can be obtained by applying a solid electrolyte slurry intermittently onto a coating substrate such as a polyethylene terephthalate (PET) film, applying an insulating layer onto an outer circumferential part of the solid electrolyte thereafter, drying it, subjecting it to rolling processing as necessary, and then peeling it off from the coating substrate.

Also, the solid electrolyte layer 40 having the central part 41 and the outer circumferential part 42 may be disposed on the main surface of the positive electrode active material layer or the negative electrode active material layer. In this case, for example, after a solid electrolyte is applied intermittently onto the positive electrode active material layer, an insulating layer is applied onto an outer circumferential part of the positive electrode active material layer, which is followed by drying and rolling processing as necessary.

FIG. 3 is a perspective view showing an example of a configuration of a lamination-type all-solid-state battery including the solid electrolyte layer 40 of FIG. 1, and FIG. 4 is a partial cross-sectional view taken along line I-I of a laminate constituting the all-solid-state battery of FIG. 3. An all-solid-state battery 1 may be, for example, an all-solid-state lithium ion secondary battery, an all-solid-state sodium ion secondary battery, an all-solid-state magnesium ion secondary battery, or the like.

The all-solid-state battery 1 includes a laminate 2 in which the positive electrode layer 20 and the negative electrode layer 30 are alternately laminated and the solid electrolyte layer 40 is interposed between the positive electrode layer 20 and the negative electrode layer 30. A lead-out electrode 23 of the positive electrode layer 20 is connected to an external electrode 3, and a lead-out electrode 33 of the negative electrode layer 30 is connected to an external electrode 4. The laminate 2 is housed in an exterior material 5 such as a film in a sealed state. Protective layers (not shown) may be laminated on an uppermost layer and a lowermost layer of the laminate 2.

The all-solid-state battery 1 includes the positive electrode layer 20, the negative electrode layer 30, and the solid electrolyte layer 40 disposed between the positive electrode layer 20 and the negative electrode layer 30 and including a solid electrolyte. The solid electrolyte layer 40 is formed of the solid electrolyte sheet which includes the central part 41 including the solid electrolyte and the outer circumferential part 42 positioned on the outer circumference of the central part 41 and containing the material having electrical insulating properties and non-ionic conductivity. A configuration of the solid electrolyte layer 40 is the same as that described above, and a description thereof will be omitted.

In the all-solid-state battery 1, areas of the positive electrode layer 20, the solid electrolyte layer 40, and the negative electrode layer 30 are substantially the same as each other on a plane of projection when they are projected in a lamination direction. At this time, it is preferable that shapes of the positive electrode layer 20, the solid electrolyte layer 40, and the negative electrode layer 30 be substantially the same as each other on the plane of projection. As described above, even when the areas of the positive electrode layer 20 and the negative electrode layer 30 are substantially the same, since the solid electrolyte layer 40 is formed of the solid electrolyte sheet having the outer circumferential part 42 containing the non-ion conductive insulating material, outer circumferential end portions 20a-1, 20a-2, and the like of the positive electrode layer 20 positioned right above or just below the outer circumferential part 42 do not function as an electrode. Thereby, electrolytic deposition of lithium is suppressed. Also, even when a relative positional deviation between the positive electrode layer 20 and the negative electrode layer 30 occurs to some extent at the time of forming the laminate 2, since ion conduction is not performed in the outer circumferential part 42, the electrolytic deposition of lithium can be reliably suppressed.

Next, a method of manufacturing the lamination-type all-solid-state battery 1 will be described.

First, a positive electrode mixture is prepared by mixing, for example, a positive electrode active material, a solid electrolyte, a conductive auxiliary agent, and a binder, and a positive electrode mixture slurry in which the positive electrode mixture is dispersed in a predetermined solvent is manufactured. Next, a positive electrode layer precursor (green sheet) is manufactured by applying the positive electrode mixture slurry onto the positive electrode current collector 21, the solvent is dried thereafter, which is then compressed using a roll press machine or the like to form the positive electrode active material layers 22A and 22B, and thereby the positive electrode layer 20 is manufactured. Then, a plurality of positive electrode layers 20 are prepared.

Next, a negative electrode mixture is prepared by mixing, for example, a negative electrode active material, a solid electrolyte, a conductive auxiliary agent, and a binder, and a negative electrode mixture slurry in which the negative electrode mixture is dispersed in a predetermined solvent is manufactured. Then, a negative electrode layer precursor (green sheet) is manufactured by applying the negative electrode mixture slurry onto the negative electrode current collector 31, the solvent is dried thereafter, which is then compressed using a roll press machine or the like to form the negative electrode active material layers 32A and 32B, and thereby the negative electrode layer 30 is manufactured. Then, a plurality of negative electrode layers 30 are prepared.

Next, a solid electrolyte slurry in which the solid electrolyte is dispersed in a predetermined solvent is manufactured. Then, a solid electrolyte layer precursor (green sheet) is manufactured by applying the solid electrolyte slurry onto a porous substrate, the solvent is dried thereafter, which is then compressed using a roll press machine or the like, and thereby a solid electrolyte layer substrate is manufactured. At this time, the solid electrolyte slurry may be applied onto the entire porous substrate or may be applied only onto a central part of the substrate while the solid electrolyte slurry is not applied onto an outer circumferential part thereof.

Further, a slurry of non-ion conductive insulating material in which, for example, a material having electrical insulating properties and non-ionic conductivity such as Al₂O₃ and a binder are dispersed in a predetermined solvent is manufactured. Then, a non-ion conductive material precursor is manufactured by immersing an outer circumferential part of the solid electrolyte layer substrate in the slurry of non-ion conductive insulating material, the central part 41 and the outer circumferential part 42 are formed by drying the solvent thereafter, and thereby the solid electrolyte layer 40 formed of a solid electrolyte sheet is manufactured. Then, a plurality of solid electrolyte layers 40 (solid electrolyte sheets) are prepared.

Thereafter, a laminate is formed by alternately laminating the positive electrode layer 20 and the negative electrode layer 30 and interposing the solid electrolyte layer 40 (solid electrolyte sheet) between the positive electrode layer 20 and the negative electrode layer 30. Then, the laminate 2 is formed by pressing the laminate in a vertical direction using press forming, and thereby the all-solid-state battery 1 including the laminate 2 is obtained. At this time, it is preferable that the laminate be press-formed with end surfaces of the positive electrode layer 20, the solid electrolyte layer 40, and the negative electrode layer 30 aligned (FIG. 4). Thereby, entire main surfaces of the solid electrolyte layer 40 are uniformly pressed by the positive electrode layer 20 and the negative electrode layer 30, and thus occurrence of cracks or defects at end portions of the solid electrolyte layer 40 is suppressed. Also, since a relative positional deviation between the positive electrode layer 20 and the negative electrode layer 30 at the time of forming the laminate 2 does not easily occur, electrolytic deposition of lithium is suppressed.

As described above, according to the present embodiment, since the solid electrolyte layer 40 is formed of the solid electrolyte sheet which has the central part 41 including the solid electrolyte, and the outer circumferential part 42 positioned on the outer circumference of the central part 41 and containing the non-ion conductive insulating material, the outer circumferential end portions 20a-1, 20a-2, and the like of the positive electrode layer 20 can be configured not to function as an electrode when the laminate 2 is formed using the solid electrolyte sheet. Therefore, even when a relative positional deviation between the positive electrode layer 20 and the negative electrode layer 30 occurs to some extent in the laminate 2, electrolytic deposition of lithium can be suppressed. Also, since the areas of the positive electrode layer 20, the solid electrolyte layer 40, and the negative electrode layer 30 are substantially the same as each other on the plane of projection, an unpressed portion at the outer circumferential end portion of the solid electrolyte layer 40 does not easily occur at the time of press-forming the laminate 2, the laminate 2 can be formed with uniform surface pressure in an in-plane direction of the solid electrolyte layer 40, occurrence of cracks or defects at the end portions of the solid electrolyte layer 40 can be suppressed, and thereby a yield of the all-solid-state battery 1 can be improved. Also, even when the positive electrode layer 20 or the negative electrode layer 30 repeatedly expands and contracts when the all-solid-state battery 1 is used, occurrence of cracks and fissures in the portion can be suppressed. Further, since it is possible to form the laminate 2 at a pressure higher than that in conventional cases, a dead space can be reduced by increasing a filling factor of the solid electrolyte constituting the solid electrolyte layer 40, and an initial performance, deterioration characteristics, and furthermore, an energy density of the all-solid-state battery 1 can be improved.

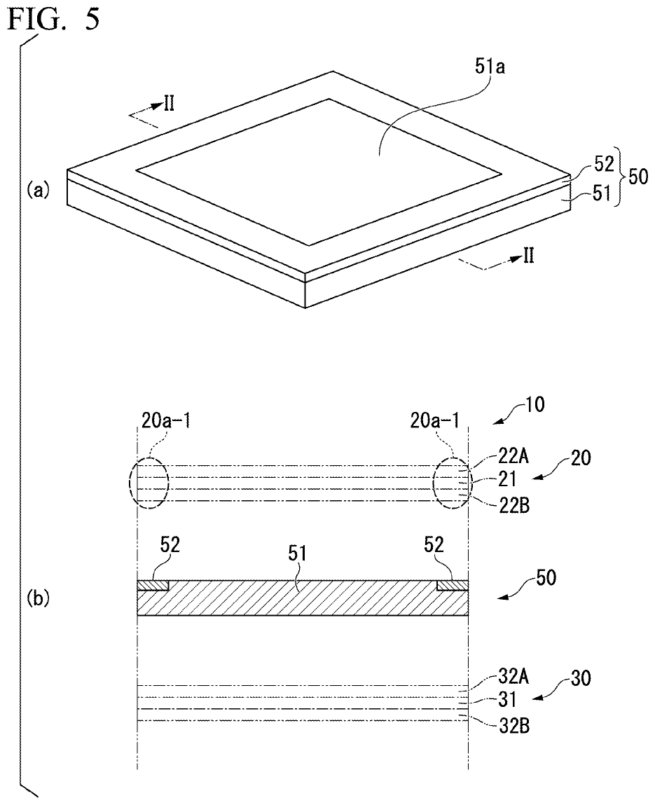

FIG. 5(a) is a perspective view showing a modified example of the solid electrolyte layer 40 (solid electrolyte sheet) of FIG. 1, and FIG. 5(b) is a cross-sectional view of the solid electrolyte layer taken along line II-II of FIG. 5(a).

As shown in FIGS. 5(a) and 5(b), a solid electrolyte layer 50 is formed of a solid electrolyte sheet which includes a central part 51 including a solid electrolyte and an outer circumferential part 52 positioned on an outer circumference of the central part 51 and containing a material having electrical insulating properties and non-ionic conductivity. The outer circumferential part 52 is a lamina-shaped part formed on a main surface of the solid electrolyte sheet. The lamina-shaped part can be formed by applying a non-ion conductive material slurry onto, for example, the main surface on the positive electrode layer 20 side of the solid electrolyte layer substrate using, for example, a printing method, a spray method, a curtain method, or the like.

Similarly to the outer circumferential part 42, the outer circumferential part 52 is preferably formed over an entire circumference of the central part 51. Thereby, electrolytic deposition of lithium can be suppressed over an entire outer circumference of the laminate unit 10 (FIG. 5(b)). Also, the lamina-shaped part is formed on one main surface of the solid electrolyte sheet but may also be formed on both main surfaces of the solid electrolyte sheet.

As described above, even with the configuration of the present modified example, when the laminate 2 is formed using the solid electrolyte sheet (see FIG. 4), the outer circumferential end portions 20a-1 and the like of the positive electrode layer 20 can be configured not to function as an electrode, and electrolytic deposition of lithium can be suppressed even when a relative positional deviation between the positive electrode layer 20 and the negative electrode layer 30 occurs to some extent in the laminate 2.

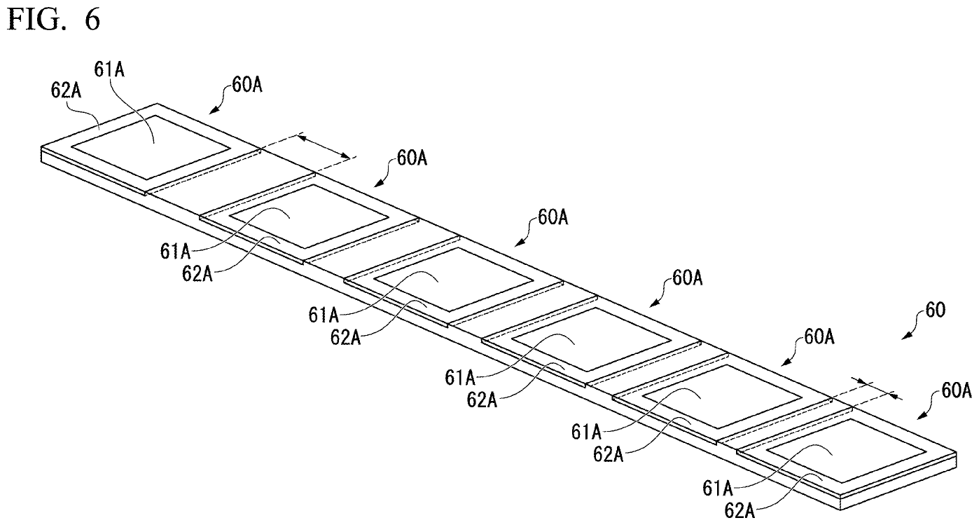

FIG. 6 is a perspective view showing an example of a configuration of a solid electrolyte sheet according to a second embodiment of the present disclosure. In the second embodiment, a solid electrolyte sheet applied to a wound type all-solid-state battery will be described as an example.

As shown in FIG. 6, a solid electrolyte layer 60 is formed of a solid electrolyte sheet in which a plurality of solid electrolyte layer units 60A each having a central part 61A including a solid electrolyte and an outer circumferential part 62A positioned on an outer circumference of the central part 61A and containing a material having electrical insulating properties and non-ionic conductivity are disposed to be arranged in a line.

In each of the solid electrolyte layer units 60A, the central part 61A includes a porous substrate and a solid electrolyte held by the porous substrate. That is, the central part 61A constitutes a part of a solid electrolyte layer substrate described above.

The outer circumferential part 62A is a lamina-shaped part formed on at least one main surface of the solid electrolyte sheet. The lamina-shaped part can be formed by applying a slurry of non-ion conductive insulating material described above onto, for example, at least one main surface of the solid electrolyte layer substrate using, for example, a printing method, a spray method, a curtain method, or the like. The outer circumferential part 62A may include a solid electrolyte in addition to the porous substrate and the non-ion conductive insulating material or may not include a solid electrolyte while including the porous substrate and the non-ion conductive insulating material.

In a plan view of the solid electrolyte layer 60 (solid electrolyte sheet), areas and shapes of the plurality of solid electrolyte layer units 60A are preferably the same as each other. Also, an arrangement pitch of the plurality of solid electrolyte layer units 60A preferably increases from one end toward the other end in a longitudinal direction of the solid electrolyte sheet. Therefore, an interval between two adjacent solid electrolyte layer units 60A increases from one end toward the other end in the longitudinal direction of the solid electrolyte sheet. Thereby, when a laminate is formed by winding the solid electrolyte sheet, end surfaces of the plurality of solid electrolyte layer units 60A can be aligned and laminated.

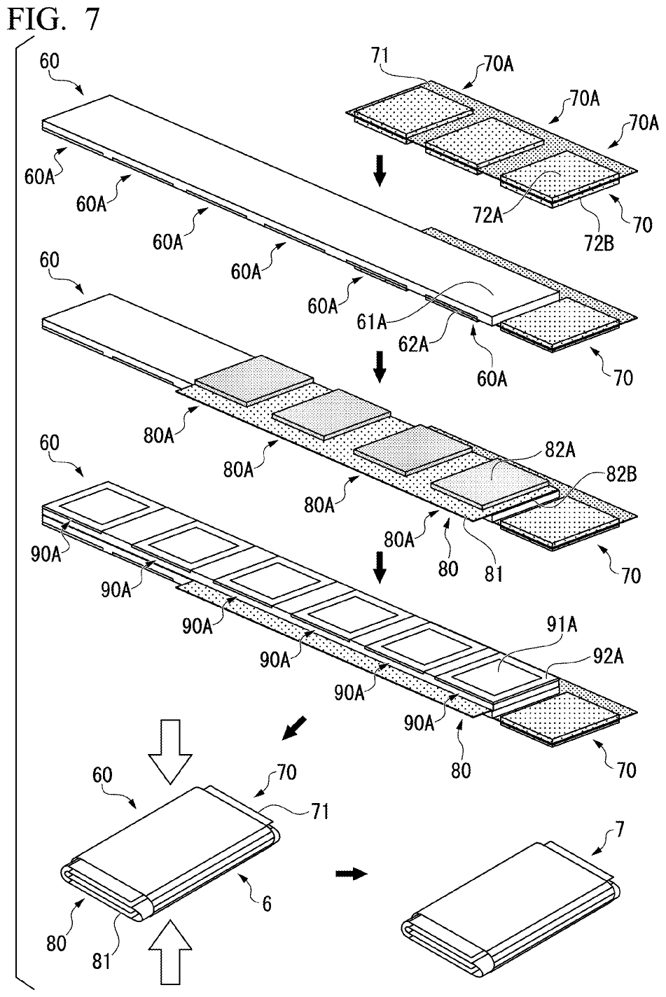

FIG. 7 is a perspective view for explaining an example of a method of manufacturing a wound type all-solid-state battery formed by winding the solid electrolyte sheet of FIG. 6.

In a case of manufacturing a wound type all-solid-state battery, first, a positive electrode layer precursor (green sheet) is manufactured by intermittently applying the same positive electrode mixture slurry as described above onto a strip-shaped positive electrode current collector 71 in a longitudinal direction, a solvent is dried thereafter, which is then compressed using a roll press machine or the like to form positive electrode active material layers 72A and 72B, and thereby a positive electrode layer 70 having a plurality of positive electrode layer units 70A is manufactured. In a plan view of the positive electrode layer 70, areas and shapes of the plurality of positive electrode layer units 70A are preferably the same as each other. Also, an arrangement pitch of the plurality of positive electrode layer units 70A preferably increases from one end toward the other end in the longitudinal direction of the positive electrode current collector 71.

Next, a solid electrolyte layer precursor (green sheet) is manufactured by intermittently applying a solid electrolyte slurry onto a strip-shaped porous substrate 61 in the longitudinal direction, a solvent is dried thereafter, which is then compressed using a roll press machine or the like, and thereby a solid electrolyte layer substrate is manufactured. Next, a non-ion conductive insulating material precursor is manufactured by applying the slurry of non-ion conductive insulating material described above in a rectangular frame shape onto a circumferential part of a portion on the main surface of the solid electrolyte layer substrate on which the solid electrolyte slurry has been applied, the central part 61A and the circumferential part 62A are formed by drying a solvent thereafter, and thereby the solid electrolyte layer 60 formed of a solid electrolyte sheet having a plurality of solid electrolyte layer units 60A is manufactured. Then, a part of the obtained solid electrolyte layer 60 is laminated on the positive electrode layer 70.

Next, a negative electrode layer precursor (green sheet) is manufactured by intermittently applying the same negative electrode mixture slurry as described above onto a strip-shaped negative electrode current collector 81 in a longitudinal direction, a solvent is dried thereafter, which is then compressed using a roll press machine or the like to form negative electrode active material layers 82A and 82B, and thereby a negative electrode layer 80 having a plurality of negative electrode layer units 80A is manufactured. Then, the obtained negative electrode layer 80 is laminated on the solid electrolyte layer 60. In a plan view of the negative electrode layer 80, areas and shapes of the plurality of negative electrode layer units 80A are preferably the same as each other. Also, an arrangement pitch of the plurality of negative electrode layer units 80A preferably increases from one end toward the other end in the longitudinal direction of the negative electrode current collector 81.

Further, in the same manner as in the solid electrolyte layer 60, a solid electrolyte layer precursor (green sheet) is manufactured by intermittently applying the solid electrolyte slurry onto a strip-shaped porous substrate 91 in a longitudinal direction, a solvent is dried thereafter, which is then compressed using a roll press machine or the like, and thereby a solid electrolyte layer substrate is manufactured. Next, a non-ion conductive insulating material precursor is manufactured by applying the slurry of non-ion conductive insulating material described above in a rectangular frame shape onto a circumferential part of a portion on the main surface of the solid electrolyte layer substrate on which the solid electrolyte slurry has been applied, a central part 91A and a circumferential part 92A are formed by drying a solvent thereafter, and thereby the solid electrolyte layer 90 formed of a solid electrolyte sheet having a plurality of solid electrolyte layer units 90A is manufactured. Then, a part of the obtained solid electrolyte layer 90 is laminated on the negative electrode layer 80.

Thereafter, in a state in which the positive electrode layer 70, the solid electrolyte layer 60, the negative electrode layer 80, and the solid electrolyte layer 90 are laminated in this order, these are wound to form a laminate. Then, a laminate 6 is formed by pressing the laminate in a vertical direction using press forming, the positive electrode current collector 71 and the negative electrode current collector 81 of the laminate 6 are respectively connected to external electrodes (not shown), and thereby an all-solid-state battery 7 is obtained. At this time, it is preferable that the laminate be press-formed with end surfaces of the positive electrode layer unit 70A, the solid electrolyte layer units 60A and 60A, the negative electrode layer unit 80A, and the solid electrolyte layer unit 90A aligned. Thereby, due to the positive electrode layer unit 70A and the negative electrode layer unit 80A, entire main surfaces of the solid electrolyte layer units 60A and 60A are uniformly pressed, an entire main surface of the solid electrolyte layer unit 90A is uniformly pressed, and thus occurrence of cracks or defects at end portions of the solid electrolyte layer 60 and the solid electrolyte layer 90 is suppressed. Also, since a relative positional deviation between the positive electrode layer unit 70A and the negative electrode layer unit 80A at the time of forming the laminate 6 does not easily occur, electrolytic deposition of lithium is suppressed.

Similarly to the all-solid-state battery 1, in the all-solid-state battery 7, areas of the positive electrode layer unit 70A, the solid electrolyte layer unit 60A, the negative electrode layer unit 80A, and the solid electrolyte layer unit 90A are substantially the same as each other on a plane of projection when they are projected in a lamination direction. At this time, it is preferable that shapes of the positive electrode layer unit 70A, the solid electrolyte layer unit 60A, the negative electrode layer unit 80A, and the solid electrolyte layer unit 90A are substantially the same as each other on the plane of projection. Thereby, the electrolytic deposition of lithium can be reliably suppressed.

As described above, according to the present embodiment, since the solid electrolyte layer 60 is formed of the solid electrolyte sheet in which the plurality of solid electrolyte layer units 60A each having the central part 61A including a solid electrolyte and the outer circumferential part 62A positioned on an outer circumference of the central part 61A and containing a non-ion conductive insulating material are disposed to be arranged in a line, the outer circumferential end portions of the positive electrode layer unit 70A can be configured not to function as an electrode when the laminate 6 is formed using the solid electrolyte sheet, and thus electrolytic deposition of lithium can be suppressed. Also, since the areas of the positive electrode layer unit 70A, the solid electrolyte layer unit 60A, the negative electrode layer unit 80A, and the solid electrolyte layer unit 90A are substantially the same as each other on the plane of projection, an unpressed portion at the outer circumferential end portions of the solid electrolyte layer units 60A and 90A does not easily occur at the time of press-forming the laminate 6, the laminate 6 can be formed with uniform surface pressure in an in-plane direction of the solid electrolyte layer units 60A and 90A, occurrence of cracks or defects at the end portions of the solid electrolyte layer units 60A and 90A can be suppressed, and a yield of the all-solid-state battery 7 can be improved. Further, since it is possible to form the laminate 6 at a pressure higher than that in conventional cases, a dead space can be reduced due to an increase in filling factor of the solid electrolyte constituting the solid electrolyte layer units 60A and 90A, and an initial performance, deterioration characteristics, and furthermore, an energy density of the all-solid-state battery 7 can be improved.

While embodiments of the present disclosure have been described above in detail, the present disclosure is not limited to the above embodiments, and various modifications and changes can be made within the gist of the present disclosure described in the claim.

For example, in the above-described embodiment, the solid electrolyte sheet has the outer circumferential part, but the present disclosure is not limited to thereto, and a separator of an aqueous lithium ion battery may have the above-described outer circumferential part. Specifically, for example, a separator may include a central part having a separator substrate and an outer circumferential part positioned on an outer circumference of the central part and containing a material having electrical insulating properties and non-ionic conductivity. The separator and the outer circumferential part in this case can be formed, for example, in shapes the same as those of the solid electrolyte layer 40 and the outer circumferential part 42 of FIG. 1.

The separator substrate is a thin film having insulating properties and is a porous body formed of a material such as, for example, a polyethylene resin, a polypropylene resin, an aramid resin, or the like. Also, the separator may have a porous body and a coating layer formed on a surface of the porous body. As the coating layer, for example, a ceramic formed of silicon oxide (SiOₓ), aluminum oxide (Al₂O₃), or the like, an aramid resin, or the like can be used.

The outer circumferential part may be, for example, an impregnated part provided integrally with the separator substrate and impregnated with a material having electrical insulating properties and non-ionic conductivity. The impregnated part can be formed by attaching the material having electrical insulating properties and non-ionic conductivity to the separator substrate using, for example, a dipping method. The material having electrical insulating properties and non-ionic conductivity can be a material the same as that of the above-described embodiment.

Also, a lithium ion battery may include a negative electrode layer, a positive electrode layer, and a separator described above disposed between the positive electrode layer and the negative electrode layer, and areas of the positive electrode layer, the separator, and the negative electrode layer may be substantially the same as each other on a plane of projection when they are projected in a lamination direction.

In the lithium-ion battery, the positive electrode layer, the negative electrode layer, and the separator which constitute the laminate are impregnated with an electrolytic solution. At this time, when an outer circumferential part is provided on the separator, an outer circumferential end portion of the positive electrode layer can be configured not to function as an electrode so that ion conduction is not performed at the outer circumferential part of the separator, and thereby electrolytic deposition of lithium can be suppressed.

While preferred embodiments of the invention have been described and shown above, it should be understood that these are exemplary examples of the invention and are not to be considered as limiting. Additions, omissions, substitutions, and other modifications can be made without departing from the spirit or scope of the present disclosure. Accordingly, the invention is not to be considered as being limited by the foregoing description and is only limited by the scope of the appended claims.

What is claimed is:

1. A solid electrolyte sheet comprising:
a central part including a solid electrolyte; and
an outer circumferential part positioned on an outer circumference of the central part and containing a material having electrical insulating properties and non-ionic conductivity.

2. The solid electrolyte sheet according to claim 1, wherein the material having electrical insulating properties and non-ionic conductivity is formed of one of a non-ion conductive insulating ceramic material and a non-ion conductive insulating resin material or formed of a composite material thereof.

3. The solid electrolyte sheet according to claim 2, wherein the non-ion conductive insulating ceramic material is formed of one or both of an oxide ceramic and a nitride ceramic.

4. The solid electrolyte sheet according to claim 3, wherein
the oxide ceramic is one or more materials selected from the group consisting of Al₂O₃, Y₂O₃, MgO, CaO, SiO₂, ZrO₂, and TiO₂, and
the nitride ceramic is one or more materials selected from the group consisting of AlN and Si₃N₄.

5. The solid electrolyte sheet according to claim 2, wherein the non-ion conductive insulating resin material is formed of one or both of a thermoplastic resin and a thermosetting resin.

6. The solid electrolyte sheet according to claim 5, wherein
the thermoplastic resin is one or more materials selected from the group consisting of polyethylene, polypropylene, polystyrene, polycarbonate, a methacrylate resin, and an ABS resin, and
the thermosetting resin is one or more materials selected from the group consisting of a phenol resin, an epoxy resin, polyurethane, a silicone resin, and an alkyd resin.

7. The solid electrolyte sheet according to claim 1, wherein the outer circumferential part is formed over an entire circumference of the central part.

8. The solid electrolyte sheet according to claim 1, wherein the outer circumferential part is formed throughout the solid electrolyte sheet in a thickness direction thereof.

9. The solid electrolyte sheet according to claim 1, wherein the outer circumferential part is an impregnated part provided integrally with the solid electrolyte sheet and impregnated with the material having electrical insulating properties and non-ionic conductivity.

10. The solid electrolyte sheet according to claim 1, wherein the outer circumferential part is a lamina-shaped part formed on a main surface of the solid electrolyte sheet.

11. An all-solid-state battery comprising:
a positive electrode layer;
a negative electrode layer; and
a solid electrolyte layer disposed between the positive electrode layer and the negative electrode layer and including a solid electrolyte, wherein
areas of the positive electrode layer, the solid electrolyte layer, and the negative electrode layer are substantially the same as each other on a plane of projection when they are projected in a lamination direction, and
the solid electrolyte layer is formed of a solid electrolyte sheet having:
a central part including the solid electrolyte; and
an outer circumferential part positioned on an outer circumference of the central part and containing a material having electrical insulating properties and non-ionic conductivity.

12. The all-solid-state battery according to claim 11, wherein the material having electrical insulating properties and non-ionic conductivity is formed of one of a non-ion conductive insulating ceramic material and a non-ion conductive insulating resin material or formed of a composite material thereof.

13. The all-solid-state battery according to claim 12, wherein the non-ion conductive insulating ceramic material is formed of one or both of an oxide ceramic and a nitride ceramic.

14. The all-solid-state battery according to claim 13, wherein
the oxide ceramic is one or more materials selected from the group consisting of Al₂O₃, Y₂O₃, MgO, CaO, SiO₂, ZrO₂, and TiO₂, and
the nitride ceramic is one or more materials selected from the group consisting of AlN and Si₃N₄.

15. The all-solid-state battery according to claim 12, wherein the non-ion conductive insulating resin material is formed of one or both of a thermoplastic resin and a thermosetting resin.

16. The all-solid-state battery according to claim 15, wherein
the thermoplastic resin is one or more materials selected from the group consisting of polyethylene, polypropylene, polystyrene, polycarbonate, a methacrylate resin, and an ABS resin, and
the thermosetting resin is one or more materials selected from the group consisting of a phenol resin, an epoxy resin, polyurethane, a silicone resin, and an alkyd resin.

17. The all-solid-state battery according to claim 11, wherein the outer circumferential part is formed over an entire circumference of the central part.

18. The all-solid-state battery according to claim 11, wherein the outer circumferential part is formed throughout the solid electrolyte sheet in a thickness direction thereof.

19. The all-solid-state battery according to claim 11, wherein the outer circumferential part is an impregnated part provided integrally with the solid electrolyte sheet and impregnated with the material having electrical insulating properties and non-ionic conductivity.

20. The all-solid-state battery according to claim 11, wherein the outer circumferential part is a lamina-shaped part formed on a main surface on the positive electrode layer side of the solid electrolyte sheet.

21. A separator comprising:
a central part including a separator substrate; and
an outer circumferential part positioned on an outer circumference of the central part and containing a material having electrical insulating properties and non-ionic conductivity.

22. A lithium-ion battery comprising:
a positive electrode layer;
a negative electrode layer; and
a separator disposed between the positive electrode layer and the negative electrode layer, wherein
areas of the positive electrode layer, the separator, and the negative electrode layer are substantially the same as each other on a plane of projection when they are projected in a lamination direction, and
the separator has:
a central part including a separator substrate; and
an outer circumferential part positioned on an outer circumference of the central part and containing a material having electrical insulating properties and non-ionic conductivity.
